(19) United States
(12) Patent Application Publication
(10) Pub. No.: US 2011/0287296 A1
(43) Pub. Date: Nov. 24, 2011

(54) THIN FILM SOLID STATE LITHIUM ION SECONDARY BATTERY AND METHOD OF MANUFACTURING THE SAME

(75) Inventors: Yuichi Sabi, Tokyo (JP); Tatsuya Furuya, Kanagawa (JP); Katsunori Takahara, Kanagawa (JP); Hiroyuki Morioka, Kanagawa (JP)

(73) Assignee: SONY CORPORATION, Tokyo (JP)

(21) Appl. No.: 13/146,594

(22) PCT Filed: Jan. 28, 2010
(86) PCT No.: PCT/JP2010/051126

§ 371 Date: Jul. 27, 2011

(30) Foreign Application Priority Data
Feb. 3, 2009 (JP) 2009-022595

(51) Int. Cl. H01M 10/02; H01M 10/04; H01M 4/131

(52) U.S. Cl. 429/127; 429/209; 429/221; 429/223; 429/224; 429/231.95; 29/623.5

(57) ABSTRACT

In one example embodiment, a thin film solid state lithium ion secondary battery is charged and discharged in the air. The thin film solid state lithium ion secondary battery has an electric insulating substrate formed from an organic resin, an insulating film made of an inorganic material and is formed on the substrate face, a cathode-side current collector film, a cathode active material film, a solid electrolyte film, an anode active material film, and an anode-side current collector film. In the thin film solid state lithium ion secondary battery, the cathode-side current collector film and/or the anode-side current collector film is formed on the foregoing insulating film face. The area of the foregoing insulating film is larger than the area of the cathode-side current collector film or the anode-side current collector film or the total area of the cathode-side current collector film and the anode-side current collector film.

### TECHNICAL FIELD

The present invention relates to a lithium ion battery, and particularly relates to a thin film solid state lithium ion secondary battery in which all layers that are formed on a substrate and compose the battery are able to be formed by dry process, and a method of manufacturing the same.

### BACKGROUND ART

A lithium ion secondary battery has a higher energy density and more superior charge and discharge cycle characteristics compared to other secondary batteries, and thus the lithium ion secondary battery is widely used as an electric power source of a mobile electronic device. In the lithium ion secondary battery using an electrolytic solution as an electrolyte, reducing its size and its thickness is limited. Thus, a polymer battery using a gel electrolyte and a thin film solid state battery using a solid electrolyte have been developed.

In the polymer battery using the gel electrolyte, reducing its size and its thickness is more easily enabled than in batteries using an electrolytic solution. However, reducing its size and its thickness is limited in order to securely seal the gel electrolyte.

The thin film solid state battery using the solid electrolyte is composed of layers formed on a substrate, that is, is composed of an anode current collector film, an anode active material film, a solid electrolyte film, a cathode active material film, and a cathode current collector film. In the thin film solid state battery using the solid electrolyte, its thickness and its size are able to be more decreased by using a thin substrate or a thin solid electrolyte film as a substrate. Further, in the thin film solid state battery, a solid nonaqueous electrolyte is able to be used as an electrolyte and the all respective layers composing the battery are able to be solid. Thus, there is no possibility that deterioration is caused by leakage, and a member for preventing leakage and corrosion is not necessitated differently from in the polymer battery using the gel electrolyte. Accordingly, in the thin film solid state battery, the manufacturing process is able to be simplified, and safety thereof may be high.

In the case where decreasing its size and its thickness is realized, the thin film solid state battery is able to be built onto an electric circuit board in a manner of on-chip. Further, in the case where a polymer substrate is used as an electric circuit board and the thin film solid state battery is formed thereon, a flexible battery is able to be formed. Such a flexible battery is able to be built in card electronic money, an RF tag and the like.

For the thin film solid state lithium ion secondary battery in which the all layers composing the battery are formed from solid described above, many reports have been made.

First, in the after-mentioned Patent document 1 entitled “SEMICONDUCTOR SUBSTRATE MOUNTED SECONDARY BATTERY,” the following description is given.

In an embodiment of Patent document 1, an insulating film is formed on a silicon substrate, a wiring electrode is formed thereon, and a cathode and an anode are respectively arranged in line on the wiring electrode. That is, the cathode and the anode are not layered. Since such arrangement is adopted, the thickness of the battery itself is able to be more decreased. Further, in the case of this embodiment, the substrate is able to be changed to an insulator.

Further, in the after-mentioned Patent document 2 entitled “THIN FILM SOLID STATE SECONDARY BATTERY AND COMPOUND DEVICE INCLUDING THE SAME,” the following description is given.

A lithium ion thin film solid state secondary battery of Patent document 2 is formed by sequentially layering a current collector layer on a cathode side (cathode current collector layer), a cathode active material layer, a solid electrolyte layer, an anode active material layer, a current collector layer on an anode side (anode current collector layer), and a moisture barrier film on a substrate. It is to be noted that the lamination on the substrate may be made in the order of the current collector layer on the anode side, the anode active material layer, the solid electrolyte layer, the cathode active material layer, the current collector layer on the cathode side, and the moisture barrier film.

As the substrate, glass, semiconductor silicon, ceramic, stainless steel, a resin substrate or the like is able to be used. As the resin substrate, polyimide, PET or the like is able to be used. Further, as long as handling is available without deformation, a flexible thin film is able to be used as the substrate. The foregoing substrates preferably have additional characteristics such as characteristics to improve transparency, characteristics to prevent diffusion of alkali element such as Na, characteristics to improve heat resistance, and gas barrier characteristics. To this end, a substrate in which a thin film such as SiO₂ and TiO₂ is formed on the surface by sputtering method or the like may be used.

Moreover, in the after-mentioned Patent document 3 entitled “A METHOD OF MANUFACTURING ALL SOLID STATE LITHIUM SECONDARY BATTERY AND ALL SOLID STATE LITHIUM SECONDARY BATTERY,” a description is given of an all solid state lithium secondary battery capable of avoiding short circuit between a cathode film and an anode film in a battery edge section.

Further, in the after-mentioned Non patent document 1, a description is given of fabricating an Li battery composed of a thin film formed by sputtering method.

### CITATION LIST

### Patent Document

Patent document 1: Japanese Unexamined Patent Application Publication No. Hei 10-284130 (paragraph 0032, FIG. 4)
Patent document 2: Japanese Unexamined Patent Application Publication No. 2008-226728 (paragraphs 0024 to 0025, FIG. 1)
Patent document 3: Japanese Unexamined Patent Application Publication No. 2008-282687 (paragraphs 0017 to 0027)

### Non Patent Document

Non patent document 1: J. B. Bates et al., “Thin-Film lithium and lithium-ion batteries,” Solid State Ionics, 135, 33-45 (2000) (2. Experimental procedures, 3. Results and discussion)

### SUMMARY OF THE INVENTION

Regarding the solid electrolyte disclosed in Non patent document 1, a thin film is able to be formed by sputtering method. In addition, since the solid electrolyte functions in a state of amorphous, crystallization by annealing is not necessitated.

Many materials used for a cathode of existing bulk Li batteries is crystal of an Li-containing metal oxide such as LiCoO₂, LiMn₂O₄, LiFePO₄, and LiNiO₂. Such a material is generally used in a state of crystal phase. Thus, in the case where a film is formed by thin film formation process such as sputtering method, in general, a substrate should be heated in forming the film and post annealing should be made after forming the film. Thus, a material with high heat resistance is used for the substrate, resulting in high cost. Further, heating process leads to longer takt time. Further, heating process causes electrode oxidation and interelectrode short circuit due to structural change at the time of crystallization of cathode material, resulting in yield lowering.

In view of manufacturing cost of the battery, a plastic substrate is preferably used. Further, from a viewpoint of using a flexible substrate, the plastic substrate is preferably used as well. In view of manufacturing cost of the battery, a material used for a cathode such as LiCoO₂, LiMn₂O₄, LiFePO₄, and LiNiO₂ is preferably formed on a plastic substrate at room temperature without providing post annealing.

The inventors of the present invention found the following. That is, the foregoing generally used cathode active materials are all deteriorated drastically to moisture. In the case where the water absorption coefficient of the plastic substrate is high, if the cathode active material is directly contacted with the substrate, generated deterioration causes short circuit, resulting in malfunction as a battery, or lowered manufacturing yield. Such deterioration and lowered manufacturing yield are not able to be solved even if a protective film to protect the respective layers composing the battery is formed after forming the respective layers composing the battery.

Further, in the case where a substrate with low water absorption coefficient such as quartz glass and a Si wafer is used, in all reports on the existing thin film batteries, charge and discharge experiments of the manufactured batteries have been conducted in a dry room or in an environment filled with inert gas such as Ar and nitrogen. The reason why the charge and discharge experiments of the manufactured batteries are conducted in the environment filled with the inert gas is the fact that the respective layers and the substrate composing the battery are subject to moisture contained in the air and their deterioration based on the moisture quickly proceeds. Thus, such experiments do not have practicality.

The invention is made to solve the above-mentioned problems, and it is an object of the present invention to provide a high-performance and inexpensive thin film solid state lithium ion secondary battery that is able to be charged and discharged in the air, enables stable driving, and is able to be manufactured stably at a favorable yield even if a film composing the battery is formed from an amorphous film, and a method of manufacturing the same.

That is, the present invention relates to a thin film solid state lithium ion secondary battery having: an electric insulating substrate formed from an organic resin; an insulating film formed from an inorganic material on a face of the electric insulating substrate; a current collector film; an active material film; and a solid electrolyte film, in which the current collector film is formed on a face of the insulating film.

Further, the present invention relates to a method of manufacturing a thin film solid state lithium ion secondary battery including the steps of: forming an insulating film formed from an inorganic material on a face of an electric insulating substrate formed from an organic resin; and forming a cathode-side current collector film and/or an anode-side current collector film on a face of the insulating film.

According to the present invention, the insulating film formed from the inorganic material on the face of the electric insulating substrate is included, and the current collector film is formed tightly to the insulating film face. Thus, even if the active material film and the solid electrolyte film are formed as amorphous, these films are formed above the insulating film. Therefore, a high-performance and inexpensive thin film solid state lithium ion secondary battery that is able to be charged and discharged in the air, enables stable driving, and is able to improve durability is able to be provided.

Further, according to the present invention, the steps of: forming the insulating film formed from the inorganic material on the face of the electric insulating substrate formed from the organic resin; and forming the cathode-side current collector film and/or the anode-side current collector film on the face of the insulating film are included. Thus, the cathode-side current collector film and/or the anode-side current collector film is formed tightly to the insulating film face, and even if the cathode active material film, the solid electrolyte film, and the anode active material film are formed as amorphous, these films are formed above the insulating film. Therefore, a high-performance and inexpensive thin film solid state lithium ion secondary battery that is able to be charged and discharged in the air, enables stable driving, is able to improve durability, and is able to be manufactured stably at a favorable manufacturing yield is able to be provided.

### BRIEF DESCRIPTION OF DRAWINGS

FIG. 1 is a view explaining a schematic structure of a solid state lithium ion battery in an embodiment of the present invention.

FIG. 2 is a view explaining a schematic structure of a solid state lithium ion battery in an embodiment of the present invention.

FIG. 3 is a diagram explaining short summary of manufacturing process of the solid state lithium ion battery in the embodiment of the present invention.

FIG. 4 is a diagram explaining structures of respective layers of solid state lithium ion batteries in Examples and Comparative example of the present invention.

FIG. 5 is a diagram explaining generation frequency of initial short circuit of the solid state lithium ion batteries of Examples and Comparative example of the present invention.

FIG. 6 is a diagram explaining generation frequency of initial short circuit of the solid state lithium ion batteries of Examples and Comparative example of the present invention.

### DESCRIPTION OF EMBODIMENTS

In a thin film solid state lithium ion secondary battery of the present invention, a structure in which a current collector film includes a cathode-side current collector film and an anode-side current collector film, an active material film includes a cathode active material film and an anode active material film, and the cathode-side current collector film and/or the anode-side current collector film is formed on an insulating film face is preferable. The insulating film formed from an inorganic material is provided on an electric insulating substrate face, and the cathode-side current collector film and/or the anode-side current collector film is formed tightly to the insulating film face. Thus, even if the cathode active material film, a solid state electrolyte film, and the anode active material film are formed as amorphous, these films are formed above the insulating film. Therefore, a high-performance and inexpensive thin film solid state lithium ion secondary battery that is able to be charged and discharged in the air, enables stable driving, and is able to improve durability is able to be provided.

Further, a structure in which the area of the insulating film is larger than the area of the cathode-side current collector film or the anode-side current collector film, or the total area of the cathode-side current collector film and the anode-side current collector film is preferable. Since the area of the insulating film is larger than the area of the cathode-side current collector film or the anode-side current collector film, or the total area of the cathode-side current collector film and the anode-side current collector film, moisture permeating the electric insulating substrate is able to be prevented by the insulating film. Thus, a high-performance and inexpensive thin film solid state lithium ion secondary battery that is able to inhibit influence of moisture on the cathode-side current collector film, the cathode active material film, the solid state electrolyte film, the anode active material film, and the anode-side current collector film that compose the battery and is able to improve durability is able to be provided.

Moreover, a structure in which the inorganic material contains at least one of an oxide, a nitride, and a sulfide containing any of Si, Al, Cr, Zr, Ta, Ti, Mn, Mg, and Zn is preferable. Thereby, the moisture permeating the electric insulating substrate is able to be prevented by the insulating film. Thus, influence of moisture on the cathode-side current collector film, the cathode active material film, the solid state electrolyte film, the anode active material film, and the anode-side current collector film that compose the battery is able to be inhibited. Therefore, a high-performance and inexpensive thin film solid state lithium ion secondary battery that is able to improve durability is able to be provided.

Further, a structure in which the film thickness of the insulating film is 5 nm or more and 500 nm or less is preferable. Since the film thickness of the insulating film is 5 nm or more and 500 nm or less, the insulating film is able to prevent generation of initial short circuit of the battery, and is able to prevent short circuit caused by repeated charge and discharge of the battery. Further, bending of the electric insulating substrate and impact are tolerated and cracks are not generated. Thus, a high-performance and inexpensive thin film solid state lithium ion secondary battery that is able to prevent short circuit and is able to improve durability is able to be provided.

Further, a structure in which the film thickness of the insulating film is 10 nm or more and 200 nm or less is preferable. Since the film thickness of the insulating film is 10 nm or more and 200 nm or less, sufficient film thickness is more stably obtained, the defective fraction due to initial short circuit is able to be more decreased, and a function as a battery is able to be retained even if the electric insulating substrate is bent.

Further, a structure in which the electric insulating substrate has flexibility is preferable. Since the electric insulating substrate has flexibility, a thin film solid state lithium ion secondary battery that is able to be suitably used for a mobile electron device and a thin electron device is able to be provided.

Further, a structure in which the cathode active material film is formed from an oxide containing at least one of Mn, Co, Fe, P, Ni, and Si and Li is preferable. Since the cathode active material film is formed from an oxide containing at least one of Mn, Co, Fe, P, Ni, and Si and Li, a thin film solid state lithium ion secondary battery that has a high discharge capacity is able to be provided.

It is not be noted that in the following description, in some cases, “thin film solid state lithium ion secondary battery” is summarily given as “solid state lithium ion battery,” “thin film lithium ion battery” or the like.

The thin film solid state lithium ion secondary battery based on the present invention is the thin film sold state lithium ion secondary battery having the electric insulating substrate formed from an organic resin, the insulating film formed from the inorganic material and formed on the substrate face, the cathode-side current collector film, the cathode active material film, the solid electrolyte film, the anode active material film, and the anode-side current collector film. In the thin film solid state lithium ion secondary battery based on the present invention, the cathode-side current collector film and/or the anode-side current collector film is formed on the foregoing insulating film face, and the film thickness of the foregoing insulating film is 5 nm or more and 500 nm or less.

The area of the foregoing insulating film is larger than the area of the cathode-side current collector film or the anode-side current collector film or the total area of the cathode-side current collector film and the anode-side current collector film. The foregoing inorganic material contains at least one of an oxide, a nitride, and a sulfide. The thin film solid state lithium ion secondary battery is able to be charged and discharged in the air, has high performance, and is able to be manufactured stably at a favorable yield.

In the present invention, a plastic substrate is used, the thin film solid state lithium ion secondary battery is formed on the substrate, and the inorganic insulating film is formed at least on the portion where the substrate is contacted with the battery in the substrate face. Thereby, even if the cathode active material film, the solid state electrolyte film, and the anode active material film are formed of an amorphous film, these films are formed above the inorganic insulating film provided on the substrate face. Thus, charge and discharge in the air is able to be realized, stable driving is enabled, and high manufacturing yield and high repeated charge and discharge characteristics are able to realized.

In the case where an organic insulating substrate having high moisture permeation rate such as a polycarbonate (PC) substrate is used as a plastic substrate, if the cathode-side current collector film and/or the anode-side current collector film is formed on the plastic substrate face, contact characteristics are not sufficient, and moisture permeation from the substrate causes a defect. However, by providing the inorganic insulating film at least in the region where the organic insulating substrate is contacted with the battery, the cathode-side current collector film and/or the anode-side current collector film is able to be formed tightly to the inorganic insulating film face. Further, moisture from atmosphere in which the substrate mounted with the battery is able to be blocked.

By forming the inorganic insulating film on the substrate face, the rate of short circuit caused by charge and discharge performed immediately after manufacturing (simply referred to as initial short circuit as well) is reduced, and manufacturing yield is improved. Further, since the rate of short circuit caused after repeated charge and discharge is lowered as well, the defective fraction is lowered. Further, improvement of the charge and discharge characteristics is able to be realized.

The foregoing inorganic insulating film is a simple body of an oxide, a nitride, or a sulfide of Si, Cr, Zr, Al, Ta, Ti, Mn, Mg, and Zn, or a mixture thereof. More specifically, the inorganic insulating film is Si₃N₄, SiO₂, Cr₂O₃, ZrO₂, Al₂O₃, TaO₂, TiO₂, Mn₂O₃, MgO, ZnS or the like or a mixture thereof.

The inorganic insulating film formed on the substrate is invented for the following reason. The cathode material and the current collector have each different area and each different shape, and short circuit is often generated from an edge section of a thin film composing the battery. That is, it is effective to form the inorganic insulating film on the substrate to cover all regions of the material composing the battery.

As the battery is the thin film battery, the inorganic insulating film should be dense and uniform, and the surface of the inorganic insulating film should be smooth equally to the substrate surface. Since a sufficient film thickness is necessitated as the inorganic insulating film, the inorganic insulating film is preferably 5 nm or more. If the thickness of the inorganic insulating film is excessively large, film peeling and cracks are easily generated due to high internal stress of the inorganic insulating film. In particular, in the case of a flexible substrate, such cracks are easily generated in bending the substrate. Thus, the film thickness is preferably 500 nm or less.

According to the present invention, even if the films composing the battery are formed from an amorphous film, the battery is formed on the inorganic insulating film provided on the substrate face. Thus, a thin film solid state lithium ion secondary battery that is able to be charged and discharged in the air, enables stable driving, and is able to improve durability is able to be provided.

A description will be hereinafter given in detail of the embodiments of the present invention with reference to the drawings.

### Embodiment (1)

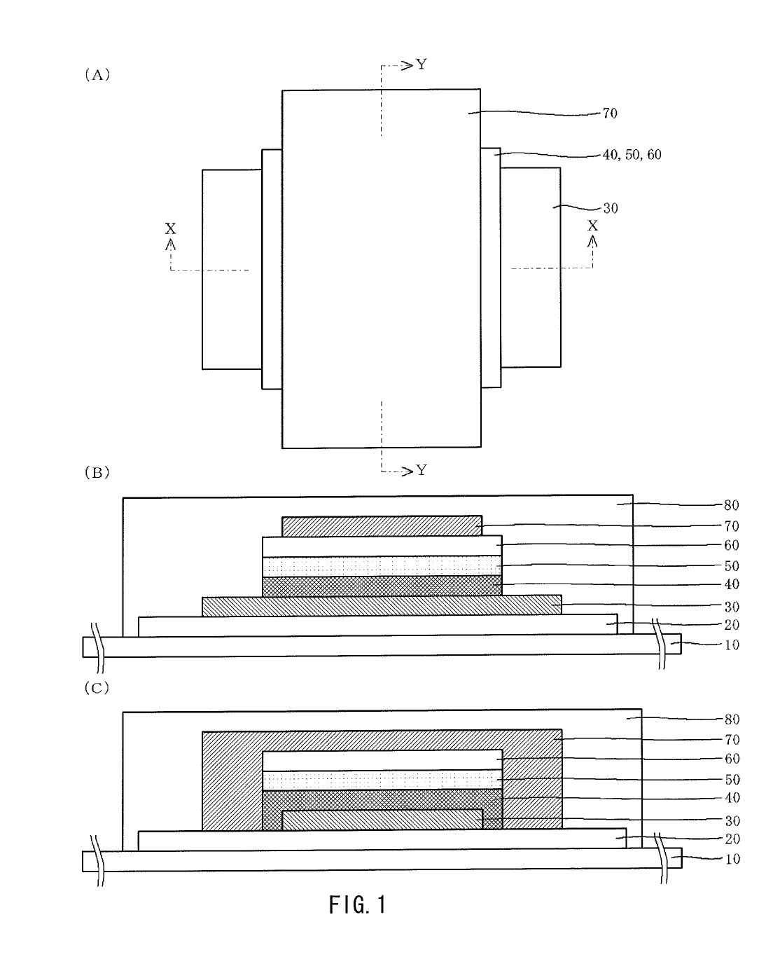

FIG. 1 is a view explaining a schematic structure of a solid state lithium ion battery in an embodiment (1) of the present invention. FIG. 1(A) is a plan view, FIG. 1(B) is an X-X cross sectional view, and FIG. 1(C) is a Y-Y cross sectional view.

As illustrated in FIG. 1, the solid state lithium ion battery has an inorganic insulating film 20 formed on a face of a substrate (organic insulating substrate) 10. The solid state lithium ion battery has a laminated body in which a cathode-side current collector film 30, a cathode active material film 40, a solid electrolyte film 50, an anode active material film 60, and an anode-side current collector film 70 are sequentially formed on the inorganic insulating film 20. An overall protective film 80 made of, for example, an ultraviolet curing resin is formed to wholly cover the laminated body and the inorganic insulating film 20.

The battery film structure illustrated in FIG. 1 is the substrate/the inorganic insulating film/the cathode-side current collector film/the cathode active material film/the solid electrolyte film/the anode active material film/the anode-side current collector film/the overall protective film.

It is to be noted that a structure in which a plurality of the foregoing laminated bodies are sequentially layered and formed on the inorganic insulating film 20, are electrically connected in series, and are covered by the overall protective film 80 is preferable. Further, a structure in which a plurality of the foregoing laminated bodies are arranged and formed in line on the inorganic insulating film 20, are electrically connected in parallel or in series, and are covered by the overall protective film 80 is also possible.

Further, in the formation of the laminated body described above, the laminated body is able to be formed in the order of the anode-side current collector film 70, the anode active material film 60, the solid electrolyte film 50, the cathode active material film 40, and the cathode-side current collector film 30 on the inorganic insulating film 20. That is, the battery film structure is able to be the substrate/the inorganic insulating film/the anode-side current collector film/the anode active material layer/the solid electrolyte film/the cathode active material film/the cathode-side current collector film/the overall protective film.

### Embodiment (2)

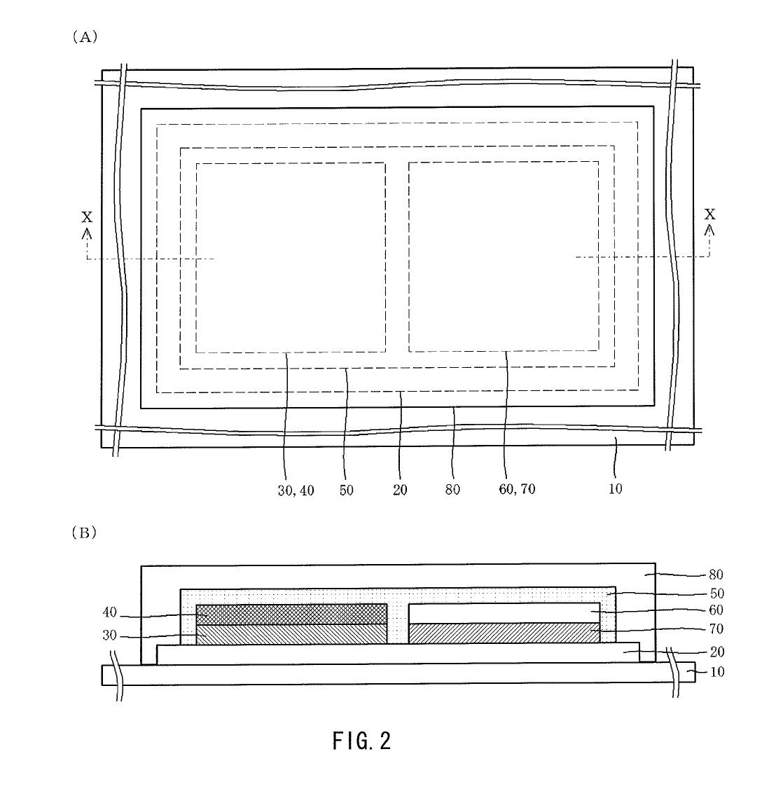

FIG. 2 is a view explaining a schematic structure of a solid state lithium ion battery in an embodiment (2) of the present invention. FIG. 2(A) is a plan view and FIG. 2(B) is an X-X cross sectional view.

As illustrated in FIG. 2, the solid state lithium ion battery has the inorganic insulating film 20 formed on a face of the substrate (organic insulating substrate) 10. The solid state lithium ion battery has a laminated body composed of the cathode-side current collector film 30 and the cathode active material film 40 and a laminated body composed of the anode-side current collector film 70 and the anode active material film 60. The solid electrolyte film 50 is formed to wholly cover the foregoing two laminated bodies arranged in line on the inorganic insulating film 20, and the overall protective film 80 made of, for example, an ultraviolet curing resin is formed to wholly cover the solid electrolyte film 50.

It is to be noted that a structure in which a plurality of sets of the foregoing two laminated bodies are arranged and formed in line on the inorganic insulating film 20, are electrically connected in parallel or in series, and are covered by the overall protective film 80 is also possible.

[Manufacturing Process of the Solid State Lithium Ion Battery]

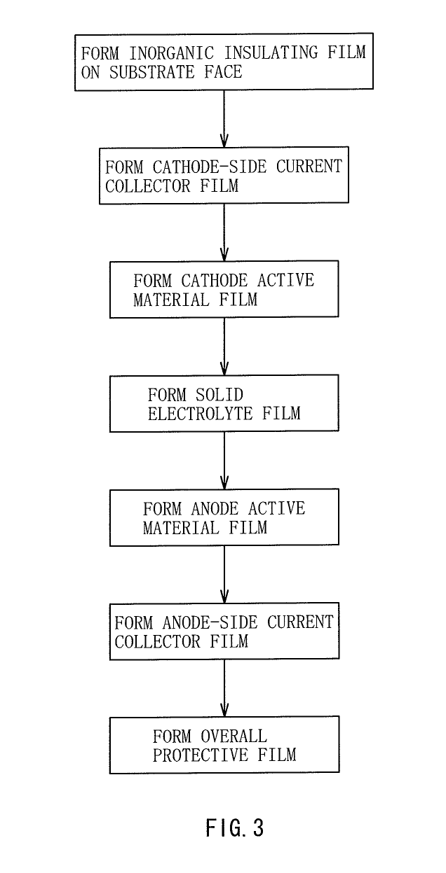

FIG. 3 is a diagram explaining short summary of manufacturing process of the solid state lithium ion battery in the embodiment of the present invention.

As illustrated in FIG. 3, first, the inorganic insulating film 20 is formed on the face of the substrate (organic insulating substrate) 10. Next, the laminated body is formed by sequentially forming the cathode-side current collector film 30, the cathode active material film 40, the solid electrolyte film 50, the anode active material film 60, and the anode-side current collector film 70 on the inorganic insulating film 20. Finally, the overall protective film 80 made of, for example, an ultraviolet curing resin is formed on the substrate (organic insulating substrate) 10 to wholly cover the laminated body and the inorganic insulating film 20. Accordingly, the solid state lithium ion battery illustrated in FIG. 1 is able to be fabricated.

In addition, though not illustrated, the solid state lithium ion battery illustrated in FIG. 2 is able to be formed as follows. First, the inorganic insulating film 20 is formed on the face of the substrate (organic insulating substrate) 10. Next, the laminated body structured by sequentially forming the cathode-side current collector film 30 and the cathode active material film 40, and the laminated body structured by sequentially forming the anode-side current collector film 70 and the anode active material film 60 are respectively arranged and formed in line on the inorganic insulating film 20. Next, the solid electrolyte film 50 is formed to wholly cover the foregoing two laminated bodies arranged and formed in line on the inorganic insulating film 20. Finally, the overall protective film 80 made of, for example, an ultraviolet curing resin is formed on the inorganic insulating film 20 to wholly cover the solid electrolyte film 50.

In the embodiments described above, as a material composing the solid state lithium ion battery, the following materials are able to be used.

As a material composing the solid electrolyte film 50, lithium phosphate (Li₃PO₄), Li₃PO₄Nₓ (generally called LiPON) obtained by adding nitrogen to lithium phosphate (Li₃PO₄), LiBO₂Nₓ, Li₄SiO₄—Li₃PO₄, Li₄SiO₄—Li₃VO₄ and the like are able to be used.

As a material composing the cathode active material film 40, a material that easily extracts and inserts lithium ions and that is able to make the cathode active material film extract and insert many lithium ions may be used. As such a material, LiMnO₂ (lithium manganese), a lithium-manganese oxide such as LiMn₂O₄ and Li₂Mn₂O₄, LiCoO₂ (lithium cobalt oxide), a lithium-cobalt oxide such as LiCO₂O₄, LiNiO₂ (lithium nickel oxide), a lithium-nickel oxide such as LiNi₂O₄, a lithium-manganese-cobalt oxide such as LiMnCoO₄ and Li₂MnCoO₄, a lithium-titanium oxide such as Li₄Ti₅O₁₂ and LiTi₂O₄, LiFePO₄ (lithium iron phosphate), titanium sulfide (TiS₂), molybdenum sulfide (MoS₂), iron sulfide (FeS, FeS₂), copper sulfide (CuS), nickel sulfide (Ni₃S₂), bismuth oxide (Bi₂O₃), bismuth plumbate (Bi₂Pb₂O₅), copper oxide (CuO), vanadium oxide (V₆O₁₃), niobium selenide (NbSe₃) and the like are able to be used. Further, the foregoing materials are able to be used by mixture as well.

As a material composing the anode active material film 60, a material that easily inserts and extract lithium ions and that is able to make the anode active material film insert and extract many lithium ions may be used. As such a material, any of oxide of Sn, Si, Al, Ge, Sb, Ag, Ga, In, Fe, Co, Ni, Ti, Mn, Ca, Ba, La, Zr, Ce, Cu, Mg, Sr, Cr, Mo, Nb, V, Zn and the like is able to be used. Further, the foregoing oxides are able to be used by mixture as well.

Specific examples of the material of the anode active material film 60 include a silicon-manganese alloy (Si—Mn), a silicon-cobalt alloy (Si—Co), a silicon-nickel alloy (Si—Ni), niobium pentoxide (Nb₂O₅), vanadium pentoxide (V₂O₅), titanium oxide (TiO₂), indium oxide (In₂O₃), zinc oxide (ZnO), tin oxide (SnO₂), nickel oxide (NiO), indium oxide added with Sn (ITO), zinc oxide added with Al (AZO), zinc oxide added with Ga (GZO), tin oxide added with Sn (ATO), and tin oxide added with F (fluorine) (FTO). Further, the foregoing materials are able to be used by mixture as well.

As a material composing the cathode-side current collector film 30 and the anode side current collector 70, Cu, Mg, Ti, Fe, Co, Ni, Zn, Al, Ge, In, Au, Pt, Ag, Pd and the like or an alloy containing any of the foregoing elements is able to be used.

As a material composing the inorganic insulating film 20, any material that is able to form a film having low moisture absorption characteristics and moisture resistance may be used. As such a material, a simple body of an oxide, a nitride, or a sulfide of Si, Cr, Zr, Al, Ta, Ti, Mn, Mg, and Zn, or a mixture thereof is able to be used. More specifically, Si₃N₄, SiO₂, Cr₂O₃, ZrO₂, Al₂O₃, TaO₂, TiO₂, Mn₂O₃, MgO, ZnS or the like or a mixture thereof is able to be used.

The solid electrolyte film 50, the cathode active material film 40, the anode active material film 60, the cathode-side current collector film 30, the anode side current collector 70 and the inorganic insulating film 20 described above are able to be respectively formed by a dry process such as sputtering method, electron beam evaporation method, and heat evaporation method.

As the organic insulating substrate 10, a polycarbonate (PC) resin substrate, a fluorine resin substrate, a polyethylene terephthalate (PET) substrate, a polybutylene terephthalate (PBT) substrate, a polyimide (PI) substrate, a polyamide (PA) substrate, a polysulfone (PSF) substrate, a polyether sulfone (PES) substrate, a polyphenylene sulfide (PPS) substrate, a polyether ether ketone (PEEK) substrate or the like is able to be used. Though a material of the substrate is not particularly limited, a substrate having low moisture absorption characteristics and moisture resistance is more preferable.

As a material composing the overall protective film 80, any material having low moisture absorption characteristics and moisture resistance may be used. As such a material, an acryl ultraviolet curing resin, an epoxy ultraviolet curing resin or the like is able to be used. The overall protective film is able to be formed by evaporating a parylene resin film.

### EXAMPLES AND COMPARATIVE EXAMPLE

### Structures in Examples and Comparative Example and Generation Frequency of Initial Short Circuit Thereof

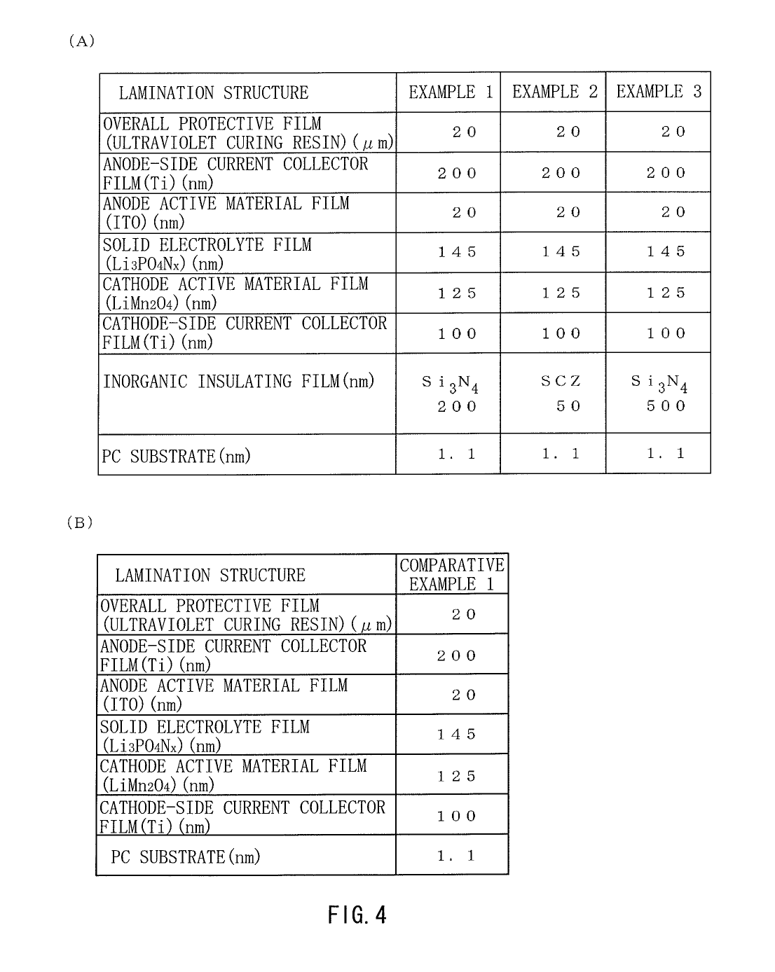

FIG. 4 is a diagram explaining structures of respective layers of solid state lithium ion batteries in Examples and Comparative example of the present invention. FIG. 4(A) and FIG. 4(B) illustrate materials and thickness of the respective layers of the solid state lithium ion batteries described below for Examples and Comparative example, respectively

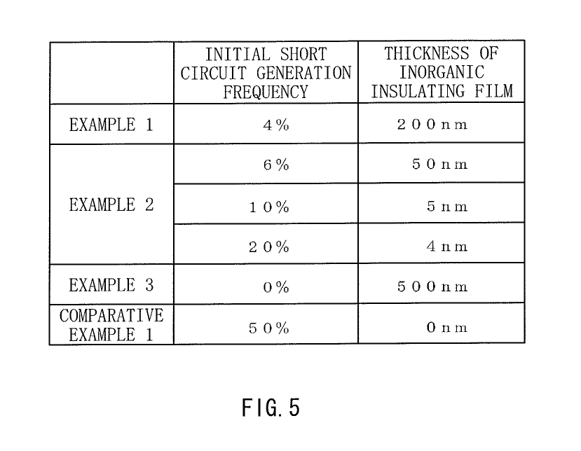

FIG. 5 is a diagram explaining generation frequency of initial short circuit of the solid state lithium ion batteries in Examples and Comparative example of the present invention.

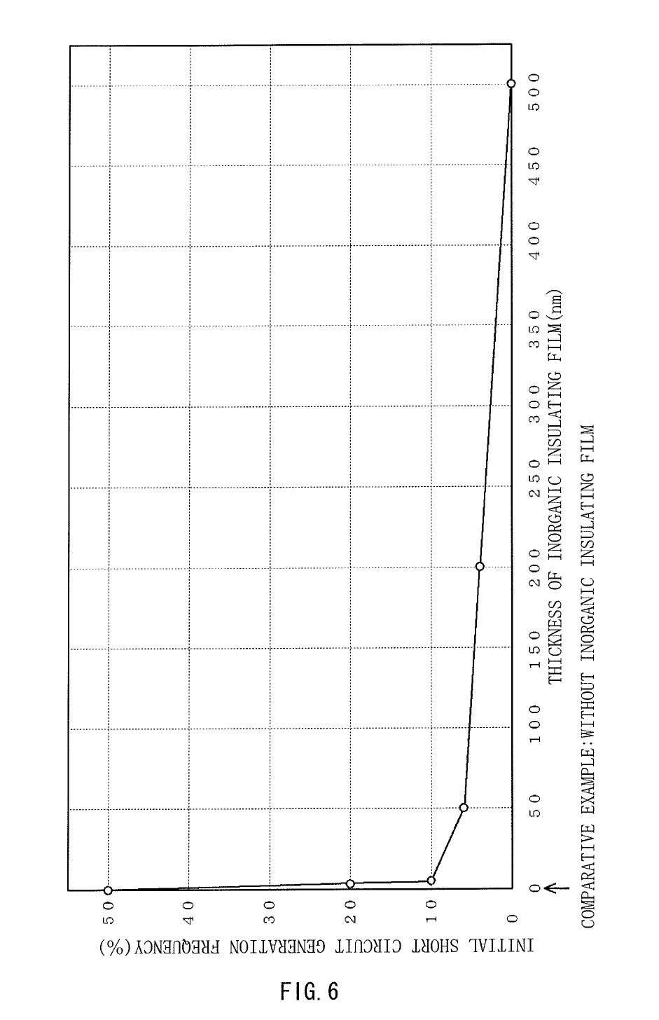

FIG. 6 is a diagram explaining generation frequency of initial short circuit of the solid state lithium ion batteries in Examples and Comparative example of the present invention.

### Example 1

Solid state lithium ion batteries having the structure illustrated in FIG. 1 were formed. Taking mass productivity and cost into consideration, a polycarbonate (PC) substrate having a thickness of 1.1 mm was used as the substrate 10. Alternately, a substrate made of a glass material, acryl or the like is able to be used. Any substrate which has no electric conductivity and in which its surface is sufficiently flat according to the film thickness of the formed battery may be used. As the inorganic insulating film 20, a Si₃N₄ film having a thickness of 200 nm was formed on the whole surface of the substrate 10.

As illustrated in FIG. 1, the laminated body was formed by sequentially forming the cathode-side current collector film 30, the cathode active material film 40, the solid electrolyte film 50, the anode active material film 60, and the anode-side current collector film 70 on the inorganic insulating film 20 with the use of a metal mask. However, the lamination order may be opposite of the foregoing order, that is, the laminated body is able to be formed by sequentially layering the anode-side current collector film 70, the anode active material film 60, the solid electrolyte film 50, the cathode active material film 40, and the cathode-side current collector film 30 on the inorganic insulating film 20.

As the metal mask, a stainless mask having a size of 500 μm was used. Alternately, a pattern is able to be formed by using lithography technology. In any case, the all films composing the foregoing laminated body are formed on the inorganic insulating film.

As the cathode-side current collector film 30 and the anode-side current collector film 70, Ti was used, and the film thickness thereof was 100 nm or 200 nm. For the cathode-side current collector film 30 and the anode-side current collector film 70, other material is able to be similarly used as long as such a material has electric conductivity and superior durability. Specifically, a metal material containing Au, Pt, Cu or the like or an alloy thereof is used. The metal material may contain an additive in order to improve durability and electric conductivity.

As the cathode active material film 40, LiMn₂O₄ was used, and the film thickness thereof was 125 nm. The film formation method of the cathode active material film 40 was sputtering method. Since the cathode active material film 40 was formed under the condition that temperature of the substrate 10 was room temperature and post annealing was not performed, the cathode active material film 40 was in amorphous state. The cathode active material film 40 is able to be formed from other material. A well-known material such as LiCoO₂, LiFePO₄, and LiNiO₂ is able to be used.

For the film thickness of the cathode active material film 40, there is no specific point to be described, except that a thicker film thickness provides a higher battery capacity. The capacity in Example 1 was 7.4 μAh, which was a sufficient amount to provide effect of the present invention. According to the application and the purpose, the film thickness of the cathode active material film 40 is able to be adjusted.

It is needless to say that in Example 1, if the cathode active material film 40 is annealed, more favorable characteristics are obtained. In the case where a plastic substrate is used, it is possible that laser annealing is used to respectively obtain high temperature for only the materials of the respective layers composing the battery. At this time, the inorganic insulating film 20 shows sufficient heat resistance while the inorganic insulating film 20 in Example 1 is contacted with the battery material. Thus, the function of protecting the respective layers composing the battery is not impaired.

Further, since the inorganic insulating film 20 has low light absorptance, the inorganic insulating film 20 is not subject to direct temperature increase due to light irradiation. In addition, since the inorganic insulating film 20 has relatively high heat conductivity, the inorganic insulating film 20 has the effect of inhibiting deterioration of the plastic substrate at the time of laser annealing.

As the solid electrolyte film 50, Li₃PO₄Nₓ was used. Since the solid electrolyte film 50 was formed under the condition that temperature of the substrate 10 in sputtering was room temperature and post annealing was not performed, the formed solid electrolyte film 50 was in amorphous state. For composition x of nitrogen in the formed solid electrolyte film 50, the accurate numerical value is unknown due to reactive sputtering of nitrogen in sputtering gas. However, the composition x of nitrogen in the formed solid electrolyte film 50 may be a value similar to that of Non-patent document 1.

In Example 1, it is apparent that similar effect is able to be obtained even if other solid electrolyte film material is used. A known material such as LiBO₂Nₓ, Li₄SiO₄—Li₃PO₄, and Li₄SiO₄—Li₃VO₄ is able to be used.

It is necessary to obtain sufficient insulation properties. Thus, in the case where the film thickness of the solid electrolyte film 50 is excessively small, there is a possibility that short circuit is generated in the initial stage or in the course of charge and discharge. Therefore, for example, the film thickness of the solid electrolyte film 50 is preferably 50 nm or more. However, the film thickness of the solid electrolyte film 50 depends not only on the film thickness and the film quality of the cathode, but also on the substrate, the current collector material, the film formation method, and the charge and discharge rate. Thus, in terms of durability, in some cases, the film thickness of the solid electrolyte film 50 is preferably larger than the foregoing value.

On the contrary, in the case where the film thickness of the solid electrolyte film 50 is excessively large, for example, in the case where the film thickness of the solid electrolyte film 50 is 500 nm or more, since the ionic conductivity of the solid electrolyte film 50 is often lower than that of a liquid electrolyte, a problem occurs in charge and discharge. Further, in the case where the solid electrolyte film 50 is formed by sputtering, if the film thickness is excessively large, sputtering time becomes longer, takt time becomes longer, and a sputtering chamber should be multi-channelized. It leads to large business investment, which is not preferable.

Thus, the film thickness of the solid electrolyte film 50 should be set to an appropriate value by taking the foregoing conditions into consideration. However, the film thickness itself is not related to the effect of the present invention. In this case, the film thickness of the solid electrolyte film 50 was 145 nm.

As the anode active film 60, an ITO film was used, and the film thickness was 20 nm.

As the anode-side current collector film 70 and the cathode-side current collector film 30, Ti was used, and the film thickness was 200 nm.

Finally, the overall protective film 80 was formed by using an ultraviolet curing resin. The overall protective film 80 functions as a protective film to moisture intrusion from the opposite side face of the substrate 10. Further, concurrently, the overall protective film 80 protects from a scratch in handling.

As the ultraviolet curing resin used in formation of the overall protective film 80, an ultraviolet curing resin under model number SK3200 made by Sony Chemical & Information Device Corporation was used. For example, other ultraviolet curing resin under model number SK5110 or the like made by Sony Chemical & Information Device Corporation is also able to be used, and similar effect is expectable. As a material used for forming the overall protective film, in particular, a material having high water resistant protective effect is preferable.

In addition, part of the ultraviolet curing resin covering the cathode side current collector 30 and the anode side current collector 70 was peeled, only the Ti metal face of the current collectors 30 and 70 was the exposed section, and such a section was used as an electrode connection terminal to avoid influence on battery durability.

In summary, the battery film structure was the polycarbonate substrate/Si₃N₄ (200 nm)/Ti (100 nm)/LiMn₂O₄ (125 nm)/Li₃PO₄Nₓ (145 nm)/ITO (20 nm)/Ti (200 nm)/ultraviolet curing resin (20 μm) (refer to FIG. 4(A)).

Note that the description has been given of only the battery function section ignoring the shape formed by the mask. However, based on the battery structure, a section where LiMn₂O₄ was directly contacted with Si₃N₄ existed.

In this case, the foregoing respective films composing the battery were formed by sputtering. However, a method such as evaporation, plating, and spray coating is able to be used as long as a battery thin film having similar film quality is able to be formed.

A description will be given of the film formation by sputtering method in detail.

For forming the Ti film, the LiMn₂O₄ film, and the Li₃PO₄Nₓ film, SMO-01 special model made by ULVAC Inc. was used. The target size was 4 inches in diameter. The sputtering conditions of the respective layers were as follows.

(1) Formation of the Ti film

Target composition: Ti

Sputtering gas: Ar 70 sccm, 0.45 Pa

Sputtering power: 1000 W (DC)

(2) Formation of the LiMn₂O₄ film

Sputtering gas: (Ar 80%+O₂ 20% mixed gas) 20 sccm, 0.20 Pa

Sputtering power: 300 W (RF)

(3) Formation of the Li₃PO₄Nₓ film

Target composition: Li₃PO₄

Sputtering gas: Ar 20 sccm+N₂ 20 sccm, 0.26 Pa

Sputtering power: 300 W (RF)

(4) Formation of the ITO film

In this case, C-3103 made by ANELVA Corporation was used. The target size was 6 inches in diameter. The sputtering conditions were as follows.

Target composition: ITO (In₂O₃ 90 wt. %+SnO₂ 10 wt. %)

Sputtering gas: Ar 120 sccm+(Ar 80%+O₂ 20% mixed gas) 30 sccm, 0.10 Pa

Sputtering power: 1000 W (DC)

In addition, sputtering time was adjusted so that a given film thickness was obtained.

Charge and discharge curve was measured by using Keithley2400, and the charge and discharge rate was 1 C in all cases (current value corresponding to completing charge and discharge in 1 hour). The charge and discharge current value in Example 1 was 8 μA.

Ten batteries having the same structure were formed by co-sputtering under identical sputtering conditions in forming the respective films. Five cycles of formation were made to obtain 50 samples in total.

For the all 50 samples, initial conduction state was examined. In the result, out of the 50 samples, initial short circuit was generated in two samples which were defectives.

### Comparative example 1

Ten batteries having the same structure as that of Example 1 except that the inorganic insulating film 20 did not provided were formed by co-sputtering for comparison. The battery film structure was the polycarbonate substrate/Ti (100 nm)/LiMn₂O₄ (125 nm)/Li₃PO₄Nₓ (145 nm)/ITO (20 nm)/Ti (200 nm)/ultraviolet curing resin (20 μm) (refer to FIG. 4(B)). For the all ten samples, initial conduction state was examined. In the result, out of the ten samples, initial short circuit was generated in five samples.

As described above, it was able to be confirmed that the inorganic insulating film 20 drastically improved yield of forming the batteries (refer to FIG. 5 and FIG. 6).

The initial short circuit was caused by conduction between the cathode side current collector and the anode side current collector for some reason. However, as evidenced by the structure illustrated in FIG. 1, if the inorganic insulating film 20 is ideally formed, conduction between the cathode side current collector and the anode side current collector is not originally occurred. That is, the inorganic insulating film 20 is formed in a wider range than the vertical width and the horizontal width of the cathode-side current collector film 30, and the anode-side current collector film 70 is formed with a smaller vertical width and a smaller horizontal width than those of the inorganic insulating film 20 on the upper side thereof. Thus, the cathode-side current collector film 30 and the anode-side current collector film 70 should not be directly contacted with each other.

However, it is suspected that the initial defect (initial short circuit) is caused by the following state. In such a state, the cathode active material film 40 having a face contacted with the substrate 10 deteriorates, and the cathode active material film 40 breaks through the solid electrolyte film 50 at the edge section of the cathode current collector film 30, and thereby the cathode current collector film 30 and the anode current collector film 70 are contacted with each other.

Next, out of the batteries according to Example 1 in which the inorganic insulating film 20 was formed, two non-defective batteries were repeatedly charged and discharged. The two non-defective batteries were able to be driven as a battery without problems in 50 cycles.

Meanwhile, out of the batteries according to Comparative example 1 in which the inorganic insulating film was not formed, two non-defective batteries were repeatedly charged and discharged. In the result, short circuit was respectively generated at the third charge for one battery and at the first charge for the other battery, resulting in defectives. It is suspected that such a defect was caused by the following state. That is, the film thickness shrunk due to the repeated charge and discharge, and film thickness was changed due to movement of Li. In particular, the cathode active material film 40 at the edge section of the cathode current collector film 30 was deteriorated and broke through the solid electrolyte film 50. Accordingly, short circuit was generated.

That is, it was clearly shown that the thin film Li battery having the structure according to Example 1 had effect to improve manufacturing yield and improve repeated charge and discharge characteristics.

### Example 2

Next, batteries similar to that of Example 1 were formed by forming 50 nm SCZ (mixture of SiO₂, Cr₂O₃, and ZrO₂) as an inorganic insulating film. The battery film structure was the polycarbonate substrate/SCZ (50 nm)/Ti (100 nm)/LiMn₂O₄ (125 nm)/Li₃PO₄Nₓ (145 nm)/ITO (20 nm)/Ti (200 nm)/ultraviolet curing resin (20 μm) (refer to FIG. 4(A)).

For forming the SCZ film, C-3103 made by ANELVA Corporation was used. The target size was 6 inches in diameter. The sputtering conditions were as follows.

Target ring composition: SCZ (SiO₂ 35 at. %+Cr₂O₃ 30 at. %+ZrO₂ 35 at. %)

Sputtering gas: Ar 100 sccm, 0.13 Pa

Sputtering power: 1000 W (RF)

In the same manner as that of Example 1, the same 50 samples were formed, and initial conduction state was examined. In the result, three samples were defectives (refer to FIG. 5 and FIG. 6). Further, the charge and discharge characteristics were approximately equal to those of Example 1. The structure in which the inorganic insulating film was provided and the battery was mounted thereon was significantly effective.

Further, in batteries in which the film thickness of SCZ was 5 nm (the battery film structure was the polycarbonate substrate/SCZ (5 nm)/Ti (100 nm)/LiMn₂O₄ (125 nm)/Li₃PO₄Nₓ (145 nm)/ITO (20 nm)/Ti (200 nm)/ultraviolet curing resin (20 μm)), out of ten samples, one sample was an initial defective. After charge and discharge were repeated for the samples without initial defect, short circuit was generated in three samples within repeated several times of charge and discharge, resulting in a defective.

Further, in batteries in which the film thickness of SCZ was 4 nm (the battery film structure was the polycarbonate substrate/SCZ (4 nm)/Ti (100 nm)/LiMn₂O₄ (125 nm)/Li₃PO₄Nₓ (145 nm)/ITO (20 nm)/Ti (200 nm)/ultraviolet curing resin (20 μm)), out of ten samples, two samples were an initial defective, which means that the defective fraction was increased. After charge and discharge were repeated for the samples without initial defect, short circuit was generated in almost all samples after repeated ten or less times of charge and discharge, resulting in a defective.

It is known that in the case where the film thickness of SCZ is decreased, for example, 4 nm, the film thickness is not formed uniformly and the film is formed in a state of island. Such a state was generated in the foregoing case, resulting in functional failure as a protective film structuring the battery. Accordingly, it is thought that the initial defective fraction was increased, and further, defect due to repeated charge and discharge was generated.

Thus, in the case where the film thickness of the inorganic insulating film 20 is excessively small, the defective fraction is increased. Accordingly, the film thickness of the inorganic insulating film 20 is preferably 5 nm or more.

### Example 3

A battery similar to that of Example 1 was formed by forming 500 nm Si₃N₄ as the inorganic insulating film 20. The battery film structure was the polycarbonate substrate/Si₃N₄ (500 nm)/Ti (100 nm)/LiMn₂O₄ (125 nm)/Li₃PO₄Nₓ (145 nm)/ITO (20 nm)/Ti (200 nm)/ultraviolet curing resin (20 μm) (refer to FIG. 4(A)). In the battery having the foregoing structure, there was no problem with the initial charge and discharge and the repeated charge and discharge characteristics.

However, it was found that the battery was subject to substrate bending and impact, and a crack was easily generated in the film. In the sample with the crack, short circuit was generated, and accordingly the sample became a defective. It is suspected that the short circuit was generated for the following reason. That is, the crack was generated in the inorganic insulating film 20 due to internal stress of the inorganic insulating film 20. Accordingly, the battery mounted above the inorganic insulating film 20 was thereby influenced.

Thus, in the case where the film thickness of the inorganic insulating film 20 is excessively large, failure is generated. Accordingly, the film thickness of the inorganic insulating film 20 is preferably 500 nm or less.

[Relation Between Bending of the Polycarbonate Substrate and Battery Function]

In the case where the polycarbonate substrate was used as the substrate 10 and SiO₂ or SCZ was used as the inorganic insulating film 20, if the film thickness of the inorganic insulating film 20 exceeded 500 nm and the polycarbonate substrate was bent to about curvature radius of 30 cm, cracks of the film composing the battery were observed.

Further, in the case where Si₃N₄ was used as the inorganic insulating film 20, if the film thickness of the inorganic insulating film 20 exceeded 300 nm and the polycarbonate substrate was bent to about curvature radius of 30 cm similarly, cracks were generated and function as a battery was stopped. In the case where the film thickness of the inorganic insulating film 20 was less than 300 nm and the polycarbonate substrate was bent to about curvature radius of 30 cm, function as a battery was retained.

[Preferable Range of Film Thickness of the Inorganic Insulating Film]

As illustrated in FIG. 6, generation frequency of battery initial short circuit is decreased as the film thickness of the inorganic insulating film 20 is increased. To obtain 10% or less defective fraction due to battery initial short circuit (generation frequency), the film thickness of the inorganic insulating film 20 is preferably 5 nm or more and 500 nm or less.

Taking variation of the film thickness at the time of forming the inorganic insulating film 20 into consideration, the film thickness of the inorganic insulating film 20 is preferably 10 nm or more and 500 nm or less in order to more stably obtain a sufficient film thickness.

Considering time needed for forming the inorganic insulating film 20 and the foregoing relation between bending of the polycarbonate substrate and battery function, the film thickness of the inorganic insulating film 20 is more preferably 10 nm or more and 200 nm or less. Thereby, a sufficient film thickness is obtained more stably, the defective fraction due to initial short circuit is able to be 10% or less, and function as a battery is able to be retained even if the substrate 10 is bent. In addition, in the case where the film thickness of the inorganic insulating film 20 is 50 nm or more and 200 nm or less, the defective fraction due to initial short circuit is able to be several % or less. In the case where the film thickness of the inorganic insulating film 20 is 200 nm or less, film formation does not need long time, and significantly short takt time nearly equal to that of optical discs is able to be realized.

As described above, according to the present invention, the battery is mounted on the inorganic insulating film provided on the substrate face. Thus, even if the films composing the battery are formed from the amorphous film, a high-performance and inexpensive thin film solid state lithium ion secondary battery that is able to be charged and discharged in the air, enables stable driving, is able to improve durability, and is able to be manufactured stably at an improved manufacturing yield is able to be provided.

The present invention has been described with reference to the embodiments. However, the present invention is not limited to the foregoing embodiments and the foregoing examples, and various modifications may be made based on the technical idea of the present invention.

### INDUSTRIAL APPLICABILITY

The present invention is able to provide a high-performance and inexpensive thin film lithium ion battery that is able to be operated in the air, enables stable driving, and is able to improve manufacturing yield.

1-9. (canceled)

10. A thin film solid state lithium ion secondary battery comprising:
an electric insulating substrate formed from an organic resin;
an insulating film formed from an inorganic material on a face of the electric insulating substrate;
a current collector film;
an active material film; and
a solid electrolyte film, wherein the current collector film is formed on a face of the insulating film

11. The thin film solid state lithium ion secondary battery of claim 10, wherein the current collector film includes a cathode-side current collector film and an anode-side current collector film, the active material film includes a cathode active material film and an anode active material film, and the cathode-side current collector film and/or the anode-side current collector film is formed on the face of the insulating film.

12. The thin film solid state lithium ion secondary battery of claim 11, wherein an area of the insulating film is larger than an area of the cathode-side current collector film or the anode-side current collector film, or a total area of the cathode-side current collector film and the anode-side current collector film

13. The thin film solid state lithium ion secondary battery of claim 11, wherein the inorganic material contains at least one of an oxide, a nitride, and a sulfide containing any of Si, Al, Cr, Zr, Ta, Ti, Mn, Mg, and Zn.

14. The thin film solid state lithium ion secondary battery of claim 11, wherein a film thickness of the insulating film is 5 nm or more and 500 nm or less.

15. The thin film solid state lithium ion secondary battery of claim 11, wherein a film thickness of the insulating film is 10 nm or more and 200 nm or less.

16. The thin film solid state lithium ion secondary battery of claim 11, wherein the electric insulating substrate has flexibility.

17. The thin film solid state lithium ion secondary battery of claim 11, wherein the cathode active material film is formed from an oxide containing at least one of Mn, Co, Fe, P, Ni, and Si and Li.

18. A method of manufacturing a thin film solid state lithium ion secondary battery comprising:
forming an insulating film formed from an inorganic material on a face of an electric insulating substrate formed from an organic resin; and
forming at least one of a cathode-side current collector film and an anode-side current collector film on a face of the insulating film.
